(19) United States
(12) Patent Application Publication
(10) Pub. No.: US 2013/0052101 A1
(43) Pub. Date: Feb. 28, 2013

(54) Laboratory Incubator Having Improved Interior Humidification

(71) Applicants: Ulrike Hohenthanner, Hanau (DE); Waldemar Pieczarek, Langenselbold (DE); Hermann Stahl, Nidderau-Ostheim (DE)

(72) Inventors: Ulrike Hohenthanner, Hanau (DE); Waldemar Pieczarek, Langenselbold (DE); Hermann Stahl, Nidderau-Ostheim (DE)

(73) Assignee: THERMO ELECTRON LED GMBH, Langenselbold (DE)

(21) Appl. No.: 13/589,383

(22) Filed: Aug. 20, 2012

(30) Foreign Application Priority Data
Aug. 24, 2011 (DE) 10 2011 111 754.0

(51) Int. Cl. F22B 37/00; B01L 3/00

(52) U.S. Cl. 422/547; 122/5.51

(57) ABSTRACT

The invention relates to a laboratory climatic cabinet, in particular a gassed incubator, having an interior enclosed by a housing and the steam generator arranged outside the interior, which is connected to the interior via a steam feed line. The steam generator is designed as an essentially unpressurized container having a base area and a steam region located above it, the base area being designed to accommodate a water reservoir and being provided with a heating device for heating the water reservoir, the steam feed line leaving the steam generator in the area of the steam region and an air feed line opening into the steam generator, in order to feed ambient air to the steam generator and to introduce air enriched with water steam via the steam feed line in essentially unpressurized form into the interior of the incubator.

### CROSS-REFERENCE TO RELATED APPLICATIONS

The present application claims priority under 35 U.S.C. §119 of German Patent Application No. 10 2011 111 754.0, filed Aug. 24, 2011, the disclosure of which is hereby incorporated herein by reference in its entirety.

### FIELD OF THE INVENTION

The present invention relates to a laboratory climatic cabinet, also referred to as an incubator, in particular a gassed incubator, having an interior enclosed by a housing and a steam generator arranged outside the interior, which is connected to the interior via a steam feed line.

### BACKGROUND OF THE INVENTION

Incubators are typically used in laboratories for the purpose of storing samples, especially biological and/or microbiological samples, in their interior under predefined conditions such as a specific temperature and ambient humidity and—in the case of gassed incubators—a defined gas atmosphere. The attempt is typically made to imitate the conditions of the human or animal body. Conditions which are often selected are therefore a temperature of approximately 37° C. and the highest possible ambient humidity, which is typically to be at least 60%, preferably at least 80%, particularly preferably at least 90%, without moisture condensing out on the walls or other areas of the incubator, however.

This various possibilities are known in the prior art for generating a humid interior atmosphere in an incubator. A first possibility is to provide a water reservoir in the interior of the incubator, from which water is vaporized by heating (for example, EP 1552888 A2). A large problem of this solution, however, is the easy microbial contamination of the water bath and the hazard of contamination of the samples stored in the incubator. This hazard of microbial contamination can be significantly reduced if superheated water steam is supplied to the interior of the incubator from the outside. For example, solutions are known in which an autoclave or sterilizer is set up outside the incubator, from which superheated water steam is fed under pressure into the incubator. However, this solution is complex and costly. In addition, these devices are subject to the safety requirements for pressure tanks, for example, the Ordinance on Industrial Safety and Health in Germany. A further disadvantage is that because of the hot steam feed into the interior of the incubator, a very high, abrupt introduction of heat occurs, which makes it difficult to maintain a constant temperature inside the incubator. In addition, water can hardly be prevented from spraying into the interior of the incubator during the feed of the steam under pressure and, under certain circumstances, precipitating on the samples stored therein.

### SUMMARY OF THE INVENTION

Therefore, there is a demand for an incubator, in the interior of which a uniformly high humidity and a constant temperature can be maintained with low expenditure and the hazard of contamination is kept as small as possible. The object of the present invention is to devise such an incubator.

Furthermore, the present invention relates to a method for operating such an incubator.

In a first aspect, the present invention thus relates to a laboratory climatic cabinet, preferably a gassed incubator, having a housing, which encloses an interior, and a steam generator arranged outside the interior, which is connected to the interior via a steam feed line. The steam generator is implemented as an essentially unpressurized container having a base area and a steam region located above it. The base area can accommodate a water reservoir, which can be heated using a heating device. An air feed line opens into the steam generator, to feed ambient air to the steam generator. In the interior of the steam generator, this ambient air is enriched with water steam and introduced essentially unpressurized into the interior of the laboratory climatic cabinet via a steam feed line, which leaves the steam generator in the area of the steam region.

In contrast to the prior art, in which water steam is generated in the interior of the incubator, an external steam generator is provided in the present invention. The presence of a contaminated water bath in the interior of the incubator is thus avoided. The present invention differs from the external steam generators of the prior art, which feed superheated water steam under pressure to the interior of the incubator, in that the steam generator is an essentially unpressurized container and the water steam is introduced essentially unpressurized into the interior of the incubator. The steam generator used according to the present invention is therefore not a pressure tank, in the interior of which an overpressure is generated to form superheated water steam. The steam generator used according to the present invention is not subject to the relevant regulations for pressure tanks or boilers, for example, the German Ordinance on Industrial Safety and Health or its precursors, the Pressure Tank and Boiler Regulations. Specifically, during the operation of the steam generator, no or only a very slight overpressure is thus generated, which is at most 0.5 bar, preferably less than 0.2 bar in any case. In addition, superheated water steam is also not generated during the operation of the steam generator, but rather the temperature of the air enriched with water steam and the water reservoir are below the boiling temperature of the water in any case, i.e., in any case less than 100° C. and preferably at most 90° C. The water steam formed in the steam generator used according to the present invention is not compressed steam, but rather is introduced essentially unpressurized (at most 0.5 bar, preferably less than 0.2 bar) into the interior of the incubator, since the water steam is generated in an essentially unpressurized container and no measures are taken to compress the water steam. Rather, a pressure equalization opening is expediently provided on at least one point of the area through which the water steam flows, preferably in the incubator.

The feed of essentially uncompressed water steam has the advantage that the introduction of heat into the interior of the incubator can be performed substantially more uniformly than is the case upon the supply of compressed hot steam. Since high pressure does not have to be generated inside the steam generator, closing valves are also not required, and, preferably, no valves are present in the steam feed line. An abrupt feed of superheated water steam after opening the valves into the interior of the incubator is therefore avoided. Rather, the water steam can be fed more uniformly into the interior. In addition, the temperature of the fed water steam is less than in the case of superheated hot steam, so that the introduction of temperature per unit of time is less and can be performed more uniformly. This makes it significantly easier to maintain a temperature consistency in the interior of the incubator. The lesser variations of the temperature and humidity also allow the moisture content in the interior to be set higher overall than in the prior art since the danger of excess humidity and therefore of water condensing out is significantly less. The danger of drying out of the samples thus advantageously also decreases.

The use of valves for closing high pressure steam generators in the prior art additionally regularly has the result that after the opening of the valves and the feed of hot steam into the interior of the incubator, water droplets spray into the interior. This problem also does not occur in the present invention, since no valves are required for closing the steam generator in relation to the incubator.

A further advantage of the essentially unpressurized generation of water steam is that feed lines having a substantially larger cross-section than in the case of the steam pressure tanks can be used. In particular in the area of the bottlenecks and valves within the feed lines, the danger exists in the prior art that contamination by germ formation will occur here. This problem is also avoided in the present invention, since feed lines having larger cross-sections without the use of valves tend substantially less toward microbial contamination and the growth of so-called biofouling and the clogs accompanying it. In addition, it has surprisingly been established that it is not necessary to heat the water to at least 100° C. to prevent the germ formation in the water reservoir of the steam generator. Rather, it is already sufficient to avoid the germ formation if the water bath is at least 60° C. Germ formation may be prevented still better if the water reservoir is heated to at least 70° C., preferably at least 80° C., and particularly preferably is kept at 85 to 90° C. As already mentioned, the water is only to be prevented from beginning to boil according to the present invention.

Upon sufficient heating of the water reservoir in the steam generator, an atmosphere strongly enriched with water steam forms above the water reservoir in the steam region. It is preferable if the steam region is saturated with water steam. In this case, the ambient air introduced into the steam generator can be rapidly enriched with water, and this air enriched with water steam, which is introduced into the interior of the incubator, results very rapidly in strong humidification of the interior atmosphere, since the internal temperature set in the incubator of, for example, 37° C. is significantly lower than the temperature of the steam-saturated air which is fed to the interior from the steam generator. The supplied air saturated with water steam thus discharges its moisture very rapidly to the interior atmosphere of the incubator.

In order to enrich the ambient air introduced into the steam generator with water steam, it is typically sufficient if the air feed line opens into the steam generator in the area of the steam region. It is normally sufficient if it is ensured that the supplied ambient air must cover a sufficiently long route through the steam region of the steam generator before it leaves the steam generator again through the steam feed line. Air feed line and steam feed line are thus expediently as far as possible away from one another. Still better enrichment of the introduced ambient air with water steam can be achieved if the air feed line opens into the steam generator in the base area, so that the ambient air passes through the water reservoir into the steam region located above it and therefrom through the steam feed line into the incubator. This steam feed line expediently leaves the steam generator in an upper area of the steam region. To prevent water which possibly condenses in the steam feed line from running into the interior of the incubator, the steam feed line is preferably arranged rising from the steam generator in the direction toward the incubator. In this case, condensed water runs out of the steam feed line back into the steam generator.

In principle, any suitable conveyor means can be used for conveying the air inside the device according to the present invention. Very simple and cost-effective conveyor means, for example, a fan or a pump, are sufficient. It is preferable to arrange the conveyor means in an area where the air is still cold and is not enriched with heated water steam, so as not to subject the conveyor means to the elevated temperature and humidity. It is therefore expedient to connect the air feed line to the conveyor means, i.e., the pump or the fan, for example, in an area before it enters the steam generator. To prevent contamination from passing with the ambient air into the steam generator and therefrom into the incubator, it is preferred to connect a filter, in particular a sterile filter, upstream or preferably downstream from the conveyor means.

In a gassed incubator, for example, a CO₂ incubator, in addition to the temperature and humidity, a specific gas atmosphere is also kept in the interior of the incubator. The gases used for this purpose are referred to hereafter as process gases to differentiate them from the air enriched with water steam which is also introduced into the incubator. The use of such process gases in gassed incubators is fundamentally already known. For example, carbon dioxide is used to set a specific pH value inside the gassed incubator, nitrogen is used to generate an inert gas atmosphere, and oxygen is used to imitate the conditions of oxygen-rich blood and promote oxidation procedures. In order that these process gases can reach the interior of the incubator, at least one gas feed line is additionally provided. This gas feed line can open directly into the interior of the incubator, for example. Since the process gases are typically available in dry form, the humidity in the interior of the incubator is reduced upon the introduction thereof. This can in turn have the result that the control of the incubator ensures an increased feed with ambient air loaded with water steam to reproduce the predefined humidity level in the interior. This then results in the displacement of the introduced process gas, which must possibly be increased again to the desired concentration by further introduction. An undesired control loop having unnecessarily elevated gas feeds thus begins. This can be avoided according to the present invention in that instead of the dry process gas, humidified process gas is introduced into the interior of the incubator. For this purpose, it is preferable for the gas feed line to open into the steam generator, in order to humidify the process gas in the steam region before it is then relayed into the interior of the incubator. In a particularly preferred embodiment of the present invention, a gas feed line for process gas is provided, which opens both into the steam generator and also into the interior of the incubator. Additional means are particularly expediently provided, for example, at least one valve, in order to feed the process gas alternately to the steam generator or the interior of the incubator. In this way, it is possible, depending on the moisture content measured for the interior, either, if the moisture content in the interior is very high, to introduce the process gas directly into the interior as dry process gas or, if the moisture content is below a predefined threshold value, to feed the process gas to the steam generator, so that it is enriched therein with moisture and it then reaches the interior of the gassed incubator. The process gas is expediently relayed from the steam generator into the gassed incubator via the steam feed line, via which humidified ambient air is also conducted into the gassed incubator.

The measurement of the operating parameters within the incubator is fundamentally performed in a manner known from the prior art. The present invention has the advantage that the fundamental construction of the incubator and the operation thereof as well as the control of the process sequences can be performed as in the prior art. Costly refitting measures are not necessary. It can be advantageous if, before or during the operation of the incubator, the ambient pressure is taken into consideration when setting the temperature of the water reservoir in the steam generator. This is advisable since the ambient pressure, which is dependent on the installation site of the incubator, has an influence on the boiling temperature of the water, but boiling of the water reservoir is to be avoided according to the present invention. In a particularly simple variant, the altitude of the installation site is correlated with the maximum temperature of the water reservoir. For example, it can be provided that the altitude of the installation site is programmed into the controller of the device before the incubator according to the present invention is put into operation, the controller then in turn ensuring that the maximum temperature of the water reservoir corresponding to the installation altitude is not exceeded, or the maximum temperature of the water reservoir is directly predefined. Alternatively, the ambient pressure can be measured using a pressure meter installed in the device, for example, a pressure sensor integrated in an infrared carbon dioxide sensor, and the maximum water temperature can be ascertained and maintained automatically.

By setting a sufficiently high temperature in the water reservoir, on the one hand, a water-steam-saturated atmosphere can be ensured in the steam region of the steam generator and, on the other hand, it can be ensured that no contamination occurs in the water reservoir. The large line cross-sections and few bottlenecks within the device according to the present invention additionally prevent contamination. Nonetheless, occasional disinfection methods are typically required in the course of the service life of the incubator according to the present invention, and these are particularly easy to carry out using the device. Dry hot air is particularly preferably used for the disinfection, which has a temperature of at least 140° C. and particularly preferably approximately 180° C., for example. This hot air can be generated in the steam generator and introduced therefrom into the incubator. For this purpose, the water of the water reservoir is expediently firstly vaporized, for which purpose the temperature is increased beyond the normal operating temperature and the water bath is brought to a boil. The dry air heated to at least 140° C. arises after the complete vaporization of the water reservoir. Therefore, no additional equipment is necessary to carry out the disinfection step. Alternatively, the hot air can be fed from an external hot air generator.

The present invention was described above in such a manner that one steam generator is provided for one incubator. However, it is also possible to connect multiple incubators to one steam generator. For this purpose, either more than one steam feed line leads out of the steam generator, namely respectively one steam line per incubator, or one steam feed line leading out of the steam generator is split and allocated to multiple incubators. A valve is expediently then provided in each of the steam lines, which can be activated separately, so that the steam feed to each of the incubators can be set individually. The use of only one steam generator for multiple incubators decreases the space requirement and the costs for the overall arrangement. If the incubators are gassed incubators, the gas feed lines are designed similarly to the steam feed lines so that the gas feed to each of the incubators can be set individually.

### BRIEF DESCRIPTION OF THE DRAWINGS

The present invention is to be explained in greater detail hereafter on the basis of a FIGURE. In the FIGURE, which is schematic and not to scale:

FIG. 1 shows a cross-section through a laboratory climatic cabinet according to one embodiment of the present invention having an attached steam generator.

### DETAILED DESCRIPTION OF THE INVENTION

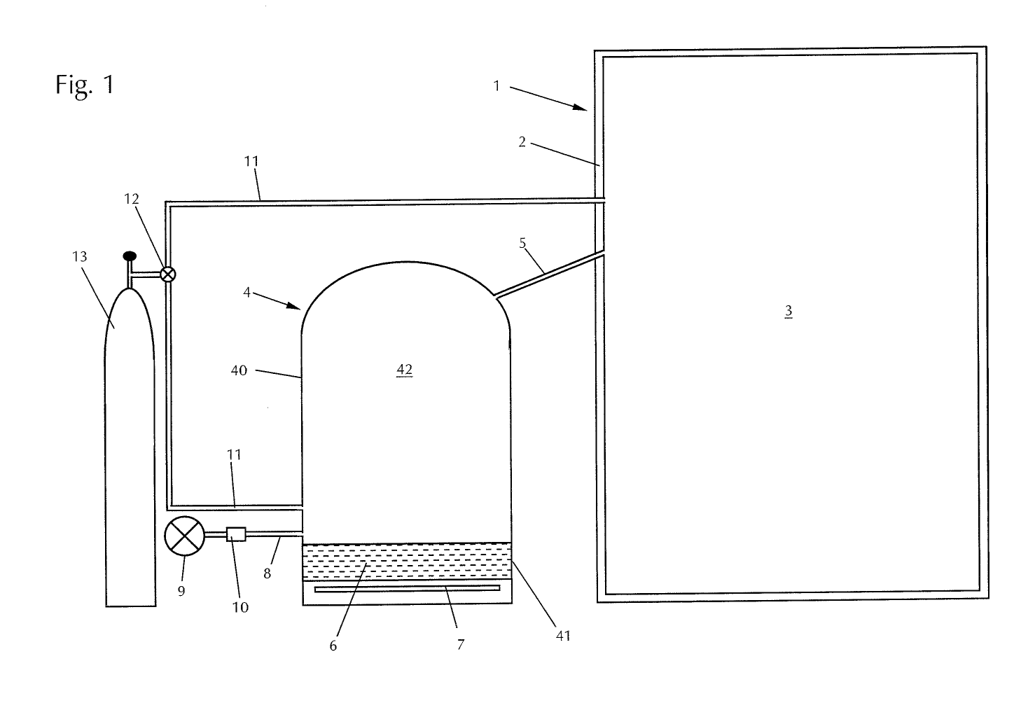

FIG. 1 describes the present invention according to one embodiment in an example of a gassed incubator (incubator) 1. The incubator 1 comprises a housing 2, which encloses an interior 3, in which, for example, microbiological samples can be stored under predefined temperature, humidity, and gas atmosphere conditions. Typical storage conditions for the samples are, for example, a temperature of 37° C. and an ambient humidity of approximately 95%. The interior 3 is closable by a door (not visible in the cross-section). The internal equipment such as support trays, measuring devices, etc. has been left out for simplification.

To generate the humidity required in the interior 3, a steam generator 4 is connected via a steam feed line 5 to the incubator 1. The steam generator 4 consists of a container 40 having a base area 41, which can accommodate a water reservoir 6, and a steam region 42 located above it, designed here in the form of a cupola. The container 40 is an unpressurized container—in contrast to boilers or pressure tanks in which an overpressure of greater than 0.5 bar prevails during operation. In the steam generator 4 according to the present invention, in contrast, water steam, which is generated by heating the water reservoir 6 by means of a heating device 7, is not compressed in the steam generator 4, so that the steam pressure substantially corresponds to the ambient pressure and in any case is at most 0.5 bar, typically less than 0.2 bar.

The water steam present in the steam region 42 is fed to the incubator 1 in that by means of a pump 9, air is conveyed from the environment of the steam generator 4 via the air feed line 8 into the interior of the steam generator 4. In the case shown, the air feed line 8 opens above the water reservoir 6 into the steam region 42. Alternatively, it is also possible to locate the air feed line lower, so that the ambient air is guided through the water reservoir into the steam region 42. In the steam generator, the ambient air is enriched with the water steam and passes via the steam feed line 5 into the interior 3 of the incubator. In order that no contaminants are conveyed with the ambient air into the steam generator 4, a sterile filter 10 is arranged between pump 9 and steam generator 4 in the air feed line 8. The arrangement of the pump 9 before the steam generator 4 has the advantage that hot and wet air does not have to be guided through the pump. The pump 9 can therefore be designed as very simple.

The water reservoir 6 is preferably heated by means of the heating device 7 to a temperature of at least 60° C., particularly preferably to 85 to 90° C. The higher the temperature of the water reservoir 6, the lower the probability that bacteria will form in the water. The temperature of the water bath is not to be so high, however, that the water in the reservoir 6 begins to boil. A hot atmosphere which is saturated with water steam and is also at approximately 90° C. forms above the water reservoir 6. The supplied ambient air is enriched very rapidly and to a high extent with water steam in this atmosphere and is heated to a temperature which is significantly above the temperature of 37° C. prevailing in the interior 3 of the incubator. Therefore, the hot, humid air fed through the steam feed line 5 discharges moisture to the atmosphere very rapidly in the interior 3 of the incubator 1. In contrast to the typical feed of superheated water steam under pressure, the feed is not performed abruptly here, however, but rather continuously. In addition, the temperature of the humid air is lower than in the case of superheated water steam. These advantageous properties allow a very much simpler and consistent temperature regulation in the interior of the incubator. In addition, the spraying of water droplets into the interior 3 is avoided, since no valves are required in the steam feed line 5 in the device according to the present invention, so that spraying of water also does not occur during the steam feed. A further advantage in relation to the steam generation in pressure tanks is that the feed line cross-sections can be significantly larger than in the prior art. This prevents the contamination of the feed lines, since no bottlenecks are present, in which bacteria could accumulate. If water nonetheless condenses in the steam feed line 5, the arrangement of the feed line rising at an incline in the direction toward the interior 3 prevents this condensed water from reaching the interior 3. Rather, it runs back in the direction toward the steam generator 4.

To generate an inert atmosphere, a nitrogen pressure bottle 13 is arranged outside the interior 3, which is connected via gas feed lines 11 to both the steam generator 4 and also the interior 3 of the incubator 1. It can be selected via a valve 12 whether the nitrogen is to be fed to the steam generator 4 or the interior 3. This selection is preferably performed as a function of the conditions which are measured for the interior 3. The detection of the measured values, their analysis, and the control of the device are performed as is already typical in the prior art. In a way known per se, a gas feed is always performed if the measured gas concentration in the interior 3 falls below a predefined threshold value. Further values which are measured during the operation of the incubator are typically the temperature and the moisture content of the interior atmosphere. The actual value ascertained for the humidity in the interior 3 preferably determines whether nitrogen is introduced from the pressure bottle 13 directly into the interior 3 or via the steam generator 4. Since the supplied process gas is typically a dry gas, the direct feed thereof into the interior 3 results in a decrease of the humidity. If the humidity measured in the interior 3 is therefore lower than a predefined threshold value, it is preferable to introduce gas enriched with moisture into the interior 3. In this case, the gas is therefore conducted from the pressure bottle 13 by appropriate switching of the valve 12 through the steam region 42 of the steam generator 4 into the interior 3. On the way therein, it is enriched with the water steam formed in the steam generator 4 and is thus fed as humid gas into the interior 3. An undesired further decrease of the humidity in the interior 3 can be prevented in this manner. What is described here for the feed of nitrogen similarly also applies for other process gases such as carbon dioxide and oxygen. In these cases, the dosing can also be performed alternately directly or via the steam generator as a function of the humidity measured in the interior.

While the present invention has been illustrated by description of various embodiments and while those embodiments have been described in considerable detail, it is not the intention of Applicants to restrict or in any way limit the scope of the appended claims to such details. Additional advantages and modifications will readily appear to those skilled in the art. The present invention in its broader aspects is therefore not limited to the specific details and illustrative examples shown and described. Accordingly, departures may be made from such details without departing from the spirit or scope of Applicants' invention.

What is claimed is:

1. A laboratory climatic cabinet, comprising:
an interior enclosed by a housing; and
a steam generator arranged outside the interior which is connected to the interior via a steam feed line,
wherein the steam generator is designed as an essentially unpressurized container having a base area and a steam region located above it, the base area being designed to accommodate a water reservoir and being provided with a heating device for heating the water reservoir, the steam feed line leaving the steam generator in the area of the steam region and an air feed line opening into the steam generator in order to feed ambient air to the steam generator and to introduce air enriched with water steam via the steam feed line essentially unpressurized into the interior of the laboratory climatic cabinet.

2. The laboratory climatic cabinet according to claim 1, wherein the air feed line opens into the steam generator in the area of the steam region.

3. The laboratory climatic cabinet according to claim 1, wherein the air feed line opens into the steam generator in the base area, so that ambient air passing into the steam generator is conducted through the water reservoir.

4. The laboratory climatic cabinet according to claim 1, wherein the steam feed line rises from the steam generator toward a discharge into the interior.

5. The laboratory climatic cabinet according to claim 1, wherein the air feed line is connected outside the steam generator to a pump or a fan.

6. The laboratory climatic cabinet according to claim 5, wherein a sterile filter is connected upstream or downstream from the pump or the fan.

7. The laboratory climatic cabinet according to claim 1, wherein at least one gas feed line is provided for introducing a process gas, in particular carbon dioxide, nitrogen, or oxygen, into the interior.

8. The laboratory climatic cabinet according to claim 7, wherein the gas feed line is designed in one of the following ways:
the gas feed line opens into the interior,
the gas feed line opens into the steam generator to relay process gas therefrom into the interior, or
the gas feed line opens into both the steam generator and also the interior, and at least one valve is provided to alternately feed the process gas to the steam generator or the interior.

9. A method for operating a laboratory climatic cabinet according to claim 1, wherein the method comprises the following steps:
operating the heating device to heat the water reservoir and generate an atmosphere enriched with water steam in the steam region,
introducing ambient air into the steam generator,
conducting the air through the steam region to enrich the air with water steam,
feeding the air enriched with water steam through the steam feed line into the interior.

10. The method according to claim 9, wherein the water reservoir is heated to a temperature below the boiling point of water, but to at least 60° C., preferably at least 70° C., particularly preferably at least 80° C., in particular to a temperature of 85 to 90° C.

11. The method according to claim 9, wherein the temperature of the water reservoir is set as a function of the ambient pressure.

12. The method according to claim 9, wherein the introduction of the process gas is performed through the steam generator into the interior if a humidity value is ascertained in the interior which is below a predefined threshold value, and the process gas is introduced directly into the interior if the humidity value ascertained in the interior is at least equal to the threshold value.

13. The method according to claim 9, wherein a disinfection step is performed outside the regular operation of the laboratory climatic cabinet, in that the water of the water reservoir is first vaporized, and subsequently dry, heated ambient air is conducted through the steam generator, the steam feed line and the interior, the dry ambient air preferably being heated to at least 140° C., particularly preferably to approximately 180° C.

14. The laboratory climatic cabinet according to claim 1, wherein the laboratory climatic cabinet comprises a gassed laboratory climatic cabinet.

15. The method according to claim 9, wherein the laboratory climatic cabinet comprises a gassed laboratory climatic cabinet.

16. The method according to claim 11, wherein the temperature of the water reservoir is set as a function of the altitude of the installation site of the incubator.
